(19) United States
(12) Patent Application Publication
(10) Pub. No.: US 2010/0314597 A1
(43) Pub. Date: Dec. 16, 2010

(54) BARRIER FENCE SYSTEM

(75) Inventors: Juan Carlos Rodriguez, Greenlawn, NY (US); Carl L. Petrucelli, Hicksville, NY (US); Serge Dubeau, Laval (CA); Richard Mark Sobel, Old Field, NY (US)

Correspondence Address: HOFFMANN & BARON, LLP, 6900 JERICHO TURNPIKE, SYOSSET, NY, 11791, US

(73) Assignee: WILBAR INTERNATIONAL, INC., Hauppauge, NY (US)

(21) Appl. No.: 12/485,658

(22) Filed: Jun. 16, 2009

(51) Int. Cl. E04H 17/14; B23P 13/00

(52) U.S. Cl. 256/24; 29/558

(57) ABSTRACT

The present invention provides a fence system including a top rail and bottom rail spaced from each other and having opposing ends. A plurality of spaced elongate members extends between the top and bottom rails, adjacent elongate members of the plurality of elongate members defining a space therebetween. A plurality of boards is provided with one of the plurality of boards being disposed in the spaces formed by the elongate members. The plurality of boards includes opposed side edges. A pair of posts are spaced from one another and securable to the ends of the top and bottom rail. The posts each include a peripheral wall defining a post interior. The peripheral wall having a first and second rail opening formed therein for receiving the ends of the top and bottom rail respectively. The ends of the top and bottom rails extend into the post interior. The peripheral wall further including a slot formed therein. The slot extends along a portion of a length of the post between, and being bounded by, the first and second rail openings. The slot receives therein a side edge of one of the plurality of boards.

### BACKGROUND

1. Technical Field

The present disclosure relates to a fence system including preassembled fence panels securable to posts.

2. Brief Discussion of Related Art

Barrier or perimeter fencing is available in many forms and styles. Fencing may include panels which are preformed and installed between posts. Typically the posts are secured to the ground and the panels are hung between the posts. A preassembled panel typically includes rails and pickets rigidly secured thereto. Such construction is desirable when the fence is to be installed over a relatively flat ground.

However, when the terrain is sloping, difficulties arise when trying to install fencing. In order to provide a visually appealing installation is it desirable to have the posts and pickets maintain a vertically plumb orientation. One way to achieve this is to step the fence sections along a slope so each successive fence is at a different elevation than the next. This solution is usually used with preassembled fence section such as those made of wood or PVC.

Another solution for fencing to follow sloped terrain is to rack the fence sections. Racking is achieved by maintaining the posts and pickets in a vertically plumb orientation and allowing the top and bottom rails to follow the contour of the terrain. This solution, however, typically requires assembling the fence panel at the installation location so that the desired angle between the rails and posts can be set. Preformed panels, due to there rigid construction, are not typically suitable for racking.

Fencing is often used in order to create some degree of privacy for a yard. Fence panels used for privacy fencing typically include structures such as pickets or vertical boards abutting each other and the rails and posts. As the fence components shift or deform over time, the fence components may separate and leave spaces. Such spaces undermine the very purpose of a privacy fence.

Accordingly it would be desirable to provide a fence which is rackable and easily installed and also consistently provides privacy.

### SUMMARY

According to aspects illustrated herein, there is provided a fence system including a top rail and bottom rail spaced from each other and having opposing ends. A plurality of spaced elongate members extends between the top and bottom rails, adjacent elongate members of the plurality of elongate members defining a space therebetween. A plurality of boards is provided with one of the plurality of boards being disposed in the spaces formed by the elongate members. The plurality of boards includes opposed side edges. A pair of posts are spaced from one another and securable to the ends of the top and bottom rail. The posts each include a peripheral wall defining a post interior. The peripheral wall has a first and second rail opening formed therein for receiving the ends of the top and bottom rail respectively. The ends of the top and bottom rail extending into the post interior. The peripheral wall further including a slot formed therein. The slot extends along a portion of a length of the post between, and being bounded by, the first and second rail openings. The slot receives therein a side edge of one of the plurality of boards.

According to additional aspects illustrated herein, there is provided a rackable fence panel including a top rail and bottom rail spaced from each other and having opposing ends. A plurality of spaced elongate members extends between the top and bottom rails. Adjacent elongate members define a space therebetween. A plurality of boards with one of said plurality of boards being disposed in each of the spaces formed by the elongate members. A securement apparatus operably connects the elongate members to the top and bottom rails and retains the boards disposed between the elongate members. The top and bottom rail are shiftable relative to each other along longitudinal extents thereof.

According to further aspects illustrated herein, there is provided a fence system including a top rail and bottom rail spaced from each other and having opposing ends. A plurality of spaced elongate members extends between the top and bottom rails. Adjacent elongate members define a space therebetween. A board is provided including a plurality of passages extending there-through. One of the plurality of elongate members extends through each of the plurality of channels. A securement apparatus operably connects the elongate members to the top and bottom rails.

According to still further aspects illustrated herein there is provided method for forming a fence post including:
forming an elongate member having a peripheral wall bounding an interior;
removing portions of the peripheral wall to form a first and second opening adapted to each receive an end of a fence rail; and
removing a section of the peripheral wall between the first and second openings to form a slot for receiving a portion of a fence panel.

### BRIEF DESCRIPTION OF THE DRAWINGS

FIG. 1 is a top perspective view of a fence system of the present invention;

FIG. 2 is a top perspective view of a fence panel secured to posts.

FIG. 3 is an exploded perspective view of a fence panel and posts;

FIG. 4 is a top perspective view of a fence panel rail;

FIG. 5 is an elevational end view of the rail of FIG. 4 showing a picket secured thereto;

FIG. 6 is a perspective view of a picket;

FIG. 7 is an elevational end view of the picket of FIG. 6;

FIG. 8 is a cross-sectional view taken along line 8-8 of FIG. 2;

FIG. 9 is a cross-sectional view taken along line 9-9 of FIG. 2;

FIG. 10 is a side elevational view of a fence panel board;

FIG. 11 is an elevational side view of a post;

FIG. 12 is a partial top plan view of a line post showing a top rail joined thereto, with a portion of the top rail removed;

FIG. 13 is a top plan view of a corner post;

FIG. 14 is a top plan view of an end post;

FIG. 15A is a cross-sectional view of a fence panel secured to posts taken along line 15A-15A of FIG. 2 and shown in a racked position;

FIG. 15B is a detailed view of the fence panel of FIG. 15A.

FIG. 16 is a cross-sectional view of a fence panel secured to posts shown in a non-racked position.

FIG. 17 is a front elevational view of an alternative fence panel and posts.

FIG. 18 is an exploded view of the fence panel and posts of FIG. 17.

FIG. 19 is a partial sectional view of a post and top rail taken along line 19-19 of FIG. 17.

FIG. 20 is a detail view of FIG. 19.

### DETAILED DESCRIPTION

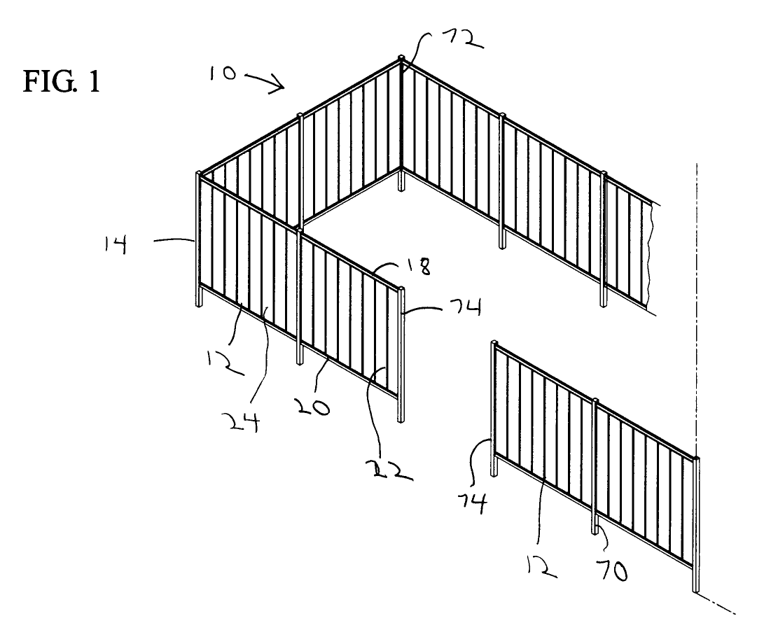

With reference to FIG. 1, a fence system 10 including a plurality of fence panels 12 is shown. The panels 12 may be pre-assembled in a unitary structure and secured between fence posts 14 forming a perimeter.

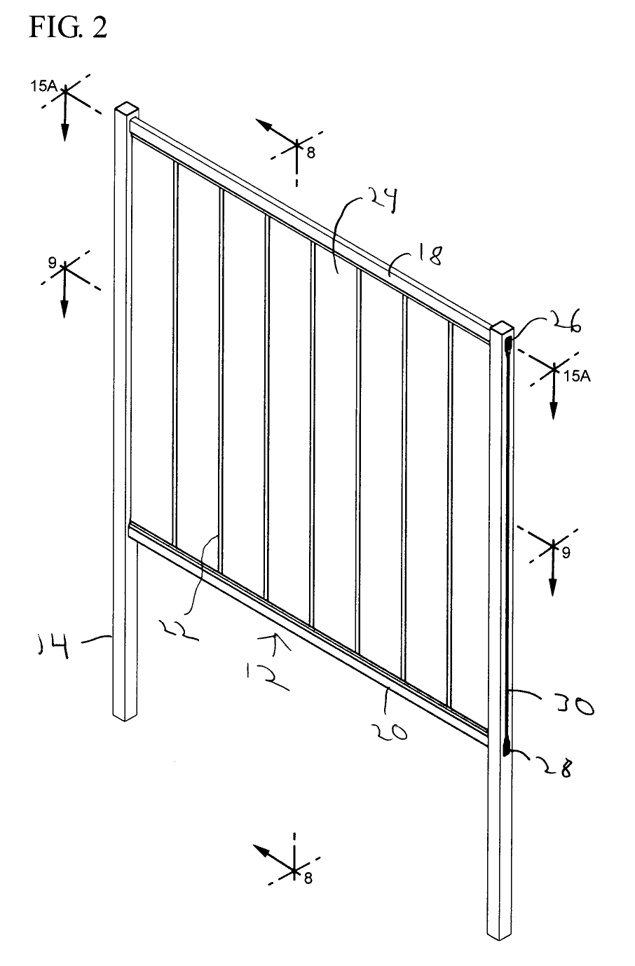

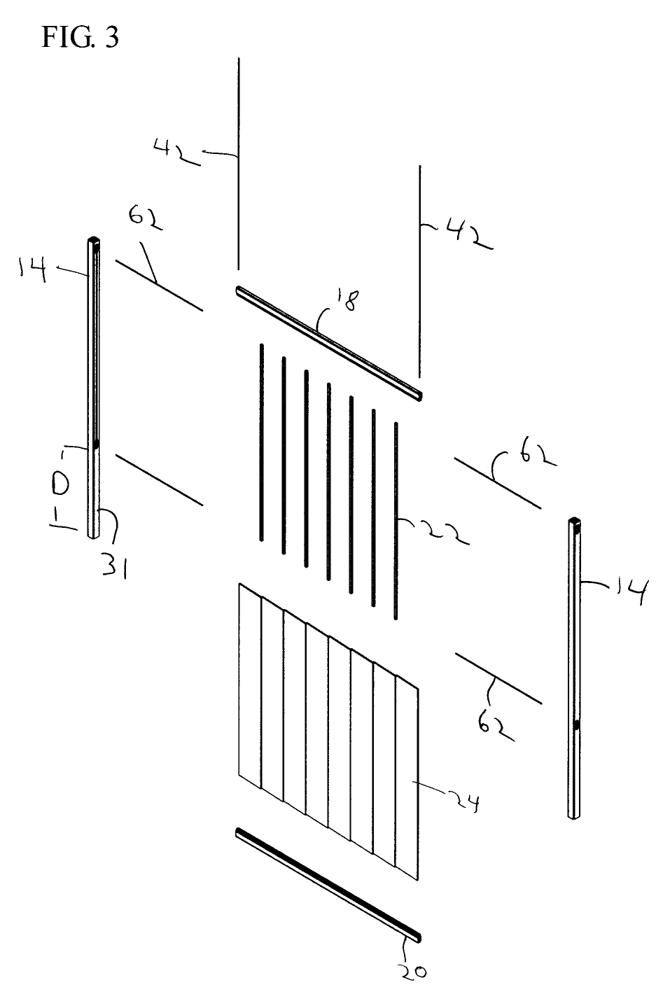

With reference to FIGS. 2 and 3, each fence panel 12 may be similarly formed and include a top rail 18 and a bottom rail 20 with a plurality of spaced pickets 22 extending there between. A space between the pickets is filled by boards 24. The boards 24 and pickets 22 preferably cooperate and are interconnected such that no openings exist in the panel 12. Therefore, the panels 12 provide a high degree of privacy.

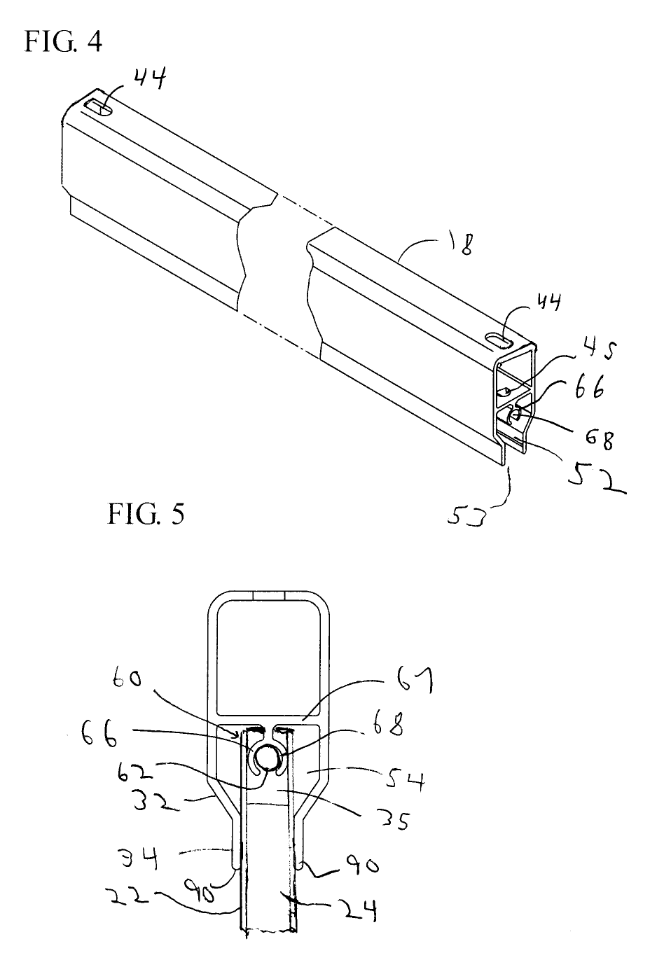

With additional reference to FIGS. 4 and 5, the top and bottom rails 18, 20 extend in a generally horizontal direction and define the upper and lower boundary of the fence panel 12. The top and bottom rails 18, 20 may be similarly formed elongate members. Preferably, the top and bottom rails 18, 20 have the same configuration with one rail being inverted with respect to the other. Top and bottom rails 18, 20 may be generally hollow structures which each including a longitudinally extending channel 52 leading to a rail interior 54. The rails 18, 20 may include a first wall portion 32 that tapers inwardly toward the channel opening 53 and a second wall portion 34 that includes parallel walls that define channel 52. It is also contemplated that the rails 18, 20 could be formed in any number of shapes. When assembled to form a fence panel 12, the top rail 18 is positioned so that the channel 52 is facing downwardly and the bottom rail 20 is positioned so that the channel 52 is facing upwardly. Channel 52 is configured to receive therein the ends of the boards 24 and the pickets 22. Accordingly, when the pickets 22 and boards 24 are assembled to the top and bottom rails 18, 20, no space exists between the top or bottom edges of the boards 24 and the top and bottom rails. Additionally, no space exists between the ends of the pickets 22 and the top and bottom rails 18, 20. The top and bottom rails 18, 20 may be formed of extruded material such as aluminum, PVC or other material known in the art.

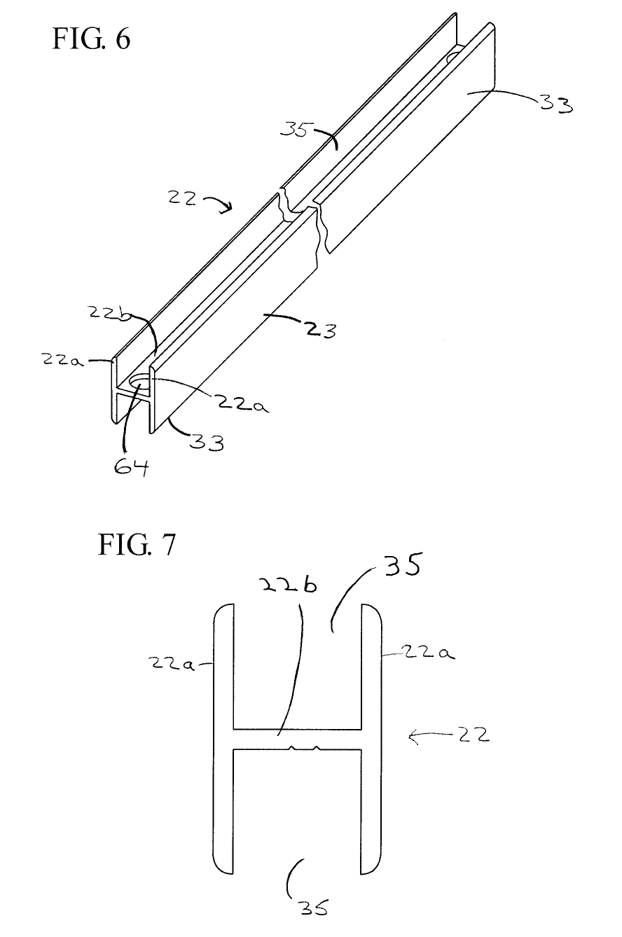

With reference to FIGS. 6 and 7, pickets 22 include elongate members extending between the top and bottom rail 18, 20 of the fence panel 12. Each picket 22 may be similarly formed; however, it is within the contemplation of the present invention that the pickets could have varying configurations. Each picket 22 may include an elongate body 23 extending between two opposed ends 33. A longitudinally extending groove 35 may be formed on each side of the picket 22. Picket 22 may have a generally H-shaped cross-section formed by two facing members 22a and a central connecting member 22b in order to provide a two-groove configuration as shown in FIG. 7. The grooves 35 may be sized to receive therein the side edges 25 of the boards 24. Since the board side edges 25 are inserted into the pickets 22, no open space exists between the pickets 22 and the boards 24. Therefore, the fence panel 12 provides significant privacy as no openings exist in the panels 12. Pickets 22 may be formed of aluminum, PVC, or other material known in the art.

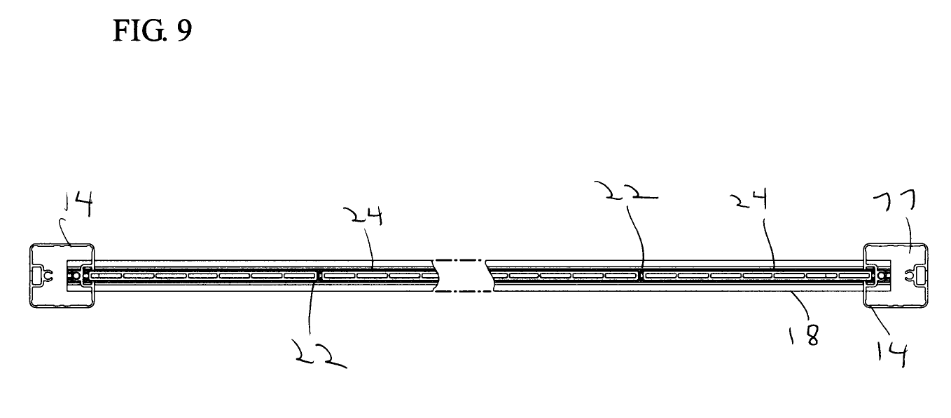

With reference to FIGS. 5, and 8-10, the plurality of boards 24 may be generally planar members formed of a variety of materials including synthetic resins, wood, aluminum, or composite material. The material may be opaque to provide a privacy feature. Boards 24 include longitudinal side edges 25 that extend into and sit within the picket grooves 35. Boards 24 disposed at the ends of the panel 12 extend between a picket 22 and a post 14. Boards 24 further include top and bottom edges 27, 29 extending between the side edges 25. Top and bottom edges 27, 29 extend into the rail channel 52 of the top and bottom rails 18, 20 respectively. Therefore, the fence panel 12 is a visually solid structure with no openings formed therein, thereby providing a great deal of privacy.

Boards 24 are supported within the fence panel 12 such that they can slide with respect to the pickets 22 and top and bottom rails 18, 20. The boards 24 essentially float within the panel 12. A clearance may exist between the side, top and bottom edges of the board and any surrounding other structure so that dimensional changes between the boards and the surrounding material can be accommodated without resulting in any damage or unwanted deformation.

The top edge 27 and bottom edge 29 of the boards may be formed such that they slope at an angle θ with respect to the board side edges 25. Accordingly, the board is not squared at the corners. A slope angle of about 3 degrees may be used, but a slope angle of about 1 to 10 degrees may also be used. Such angles are intended to be exemplary and not limiting as various angle values may be used to accommodate a specific application. The top and bottom edge 27, 29 are generally parallel to each other but at a non-right angle to the side edges 25. Accordingly the boards 24 may generally have a parallelogram shape, but not rectangular. Top and bottom edges 27, 29 formed in this manner aid in allowing the panel 12 to rack when installed on non-level terrain as will be described in further detail below.

With reference to FIGS. 3, 5 and 6, the pickets 22 may be secured to the top and bottom rails by way of a picket securement apparatus 60. Picket securement apparatus may include one or more rail rods 62 which extend through holes 64 formed in the picket ends 33. The picket securement apparatus 60 may further include a retainer 66 disposed within the rail interior 54 of the top and bottom rails. Retainer 66 may include a conduit 68 which extends along the length of the rail. The retainer 66 and its conduit 68 may be interrupted at various points along its length to permit the insertion of the picket end 33 through the channel 52 and into the rail interior 54. Retainer 66 may have a C-shaped cross-section and be sized such that it can receive at least a portion of the length of the rail rod 62 in an interference fit such that the rail rod 62 may be held securely within the retainer 66. Alternatively, retainer 66 may be fully surrounded by material and be in the form of a through-hole. Retainer 66 may be supported on a longitudinally extending cross member 67 which extends laterally across the inside of the rail interior 54.

In order to secure the pickets 22 to the top and bottom rails 18, 20, the ends of the pickets 33 are inserted through the rail channel 52 into the rail interior 54 such that the holes 64 align with the conduit 68. The rail rods 62 may then be extended into the conduit 68 through the holes 64 of the pickets. When the picket ends are secured to the rails, the various elements of the fence panels 12 are thereby locked together. When the fence panel 12 is assembled, the members of the picket securement apparatus 60 are hidden from view providing clean lines on both sides of the panel. Therefore, the panel 12 is a two-sided panel with each side providing the same pleasing appearance.

The fence panel 12 may be preassembled such that the rails, pickets and boards are secured together in a unitary structure. This makes for ease of shipping the panels 12 as well as installation of the panels at the job site to form the fence system 10. Securement of the top and bottom rails 18, 20 to the pickets 22 in this manner also permits the pickets 22 to pivot to some degree with respect to the rails 18, 20. This permits the fence panel 12 to rack.

The fence system 10 further includes posts 14 to which the fence panels 12 are secured between. With reference to FIGS. 1 and 11-14, the fence system 10 may include a variety of posts types in order to accommodate specific applications. One type of post is a line post 70, which may be used to secure two fence panels 12 together in a line such as along a substantially straight section of the fencing system. Another post type may be a corner post 72, which is used to join fence panels 12 at right angles to each other such as at a corner of the fence system 10. A further post may be an end post 74, which is used when the end of the fence system 10 is not to be secured to another panel, such as when the fence system 10 abuts a structure, or when an opening for a gate is desired. The various types of posts, referred to generically with reference number 14, may be generally similarly formed but differ mainly as to the post surfaces that receive the panels 12. Accordingly, the detailed description of the posts will be made to the line post 70 with the differences between the other post types being noted.

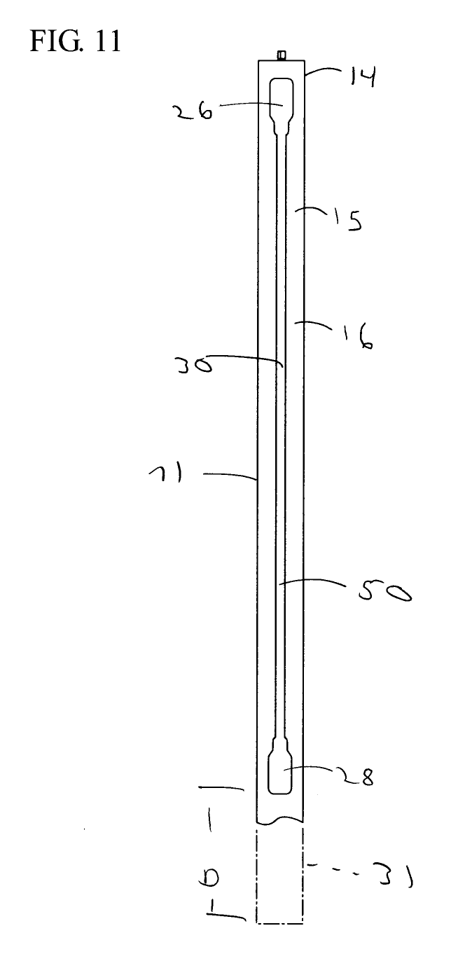

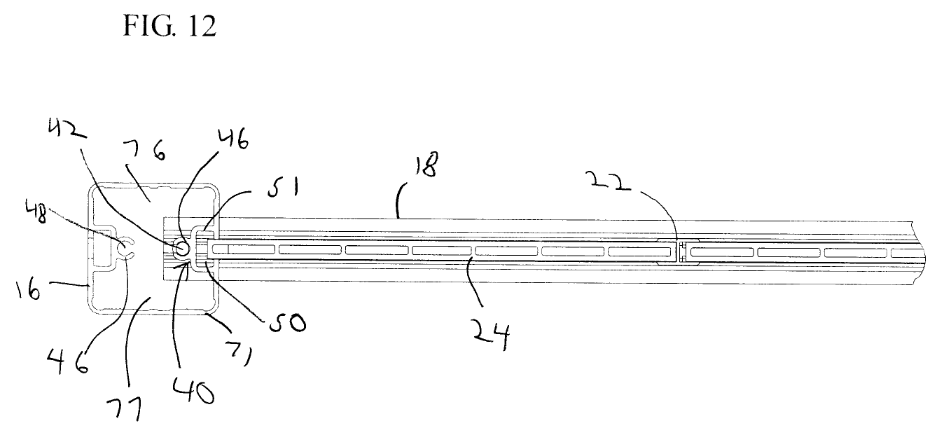

With reference to FIGS. 11 and 12, the line post 70 is a generally elongate member including a peripheral wall 71 defining a post interior 76. The peripheral wall may include a plurality of surfaces such as sidewalls 15 which are joined together to form the post perimeter. While the posts 70 are shown to be square, it is within the contemplation of the present invention that the posts could be formed in a variety of shapes having a various number of sides or be round. The posts may be formed by the extrusion of aluminum or other materials well known in the art to form an elongate extrusion. The extrusion may be parted at the desired length to form post members. The post 70 may be formed as one piece. A sidewall facing the panel 12 may be referred to as a joining wall 16 and may include a top rail opening 26 and a bottom rail opening 28 in which the end of the top and bottom rails enter the post. The top rail and bottom rail openings 26 and 28 may be configured to closely match the cross-sectional configuration of the top and bottom rails. Rail openings 26 and 28 may be sized to provide clearance between the top and bottom rails 18, 20 and the rail openings to permit the rails to pivot with respect to the posts. The bottom rail opening 28 may be disposed a distance D (FIG. 3) from the bottom edge of the post. Therefore, a significant portion of the posts extend below the bottom rail 20. The lower post portion 31 may be used to secure a fence panel 12 to the ground in a manner well known in the art.

Extending longitudinally along the post between the top rail opening 26 and the bottom rail opening 28 in the joining wall 16 is a post slot 30. The post slot 30 may be sized to receive within it the panel side edge 25 which is positioned adjacent the line post 70. Post slot 30 may be formed by removing material, such as by cutting or routing, from the post peripheral wall 71 between the top and bottom rail openings 26, 28. The slot 30 leads into a longitudinally extending pocket 50 bounded by walls 51 on three sides. The pocket 50 is disposed within a post interior 76. Accordingly, when the board side edge 25 extends into the post through the slot 30, the amount of lateral travel into the post is limited by the pocket walls 51.

With reference to FIG. 11, the top and bottom rail openings 26, 28 may be formed by removing material, such as by cutting or routing, from the peripheral wall 71. Sections of the pocket 50 are also removed in forming the top and bottom rail openings 26, 28 to provide access to the post interior 76. The rail openings 26, 28 provide a passage into the post interior 76 through which then ends of the top and bottom rails extend. The top and bottom openings 26, 28 are bounded at their periphery by the peripheral wall 71. The fence panel 12 has an end profile including the outer shape of the top and bottom rails 18, 20 and the board edge 25. The end profile is generally reproduced in the joining wall 16 by way of the rail openings 26, 28 and slot 30, so that the end of the fence panel 12 may be inserted within the post 70. The rail openings 26, 28, and the slot 30 extending there between, do not extend out beyond the ends of the posts. The slot 30, therefore, does not extend beyond the rail openings toward the ends of the post. Accordingly, the rail openings 26, 28 and slot 30 are formed in and surrounded by the material forming the post peripheral wall. When a rail 18, 20 is inserted within the appropriate rail opening, the rail is captured therein and may not be slid up and down in a direction along the length of the post. The edge of the panel fits within the slot 30. The post 70 is preferably of one piece construction and no additional components, such as fillers, spacers, or plugs, need be inserted into the post to prevent the top and bottom rails 18, 20 from moving along the length of the post 70, or to prevent dirt and water from getting within the posts. Installation of the panels 12 to the posts 14 is therefore simplified.

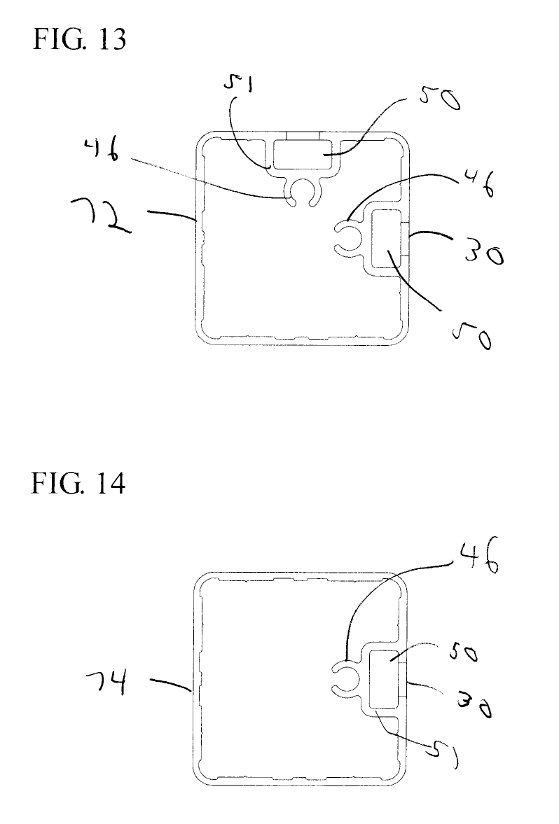

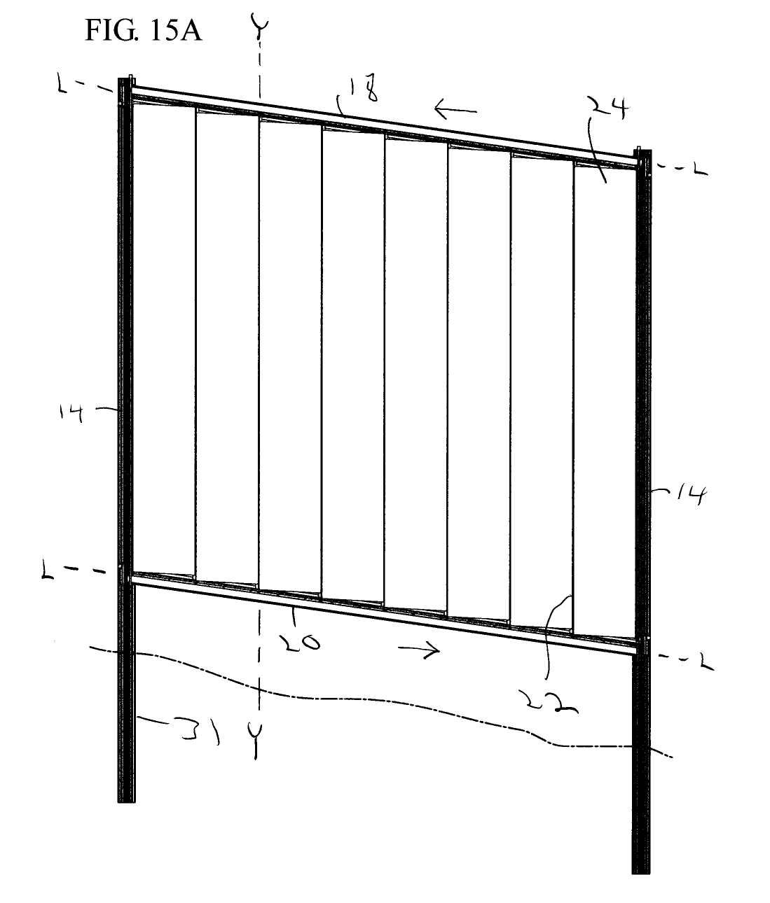

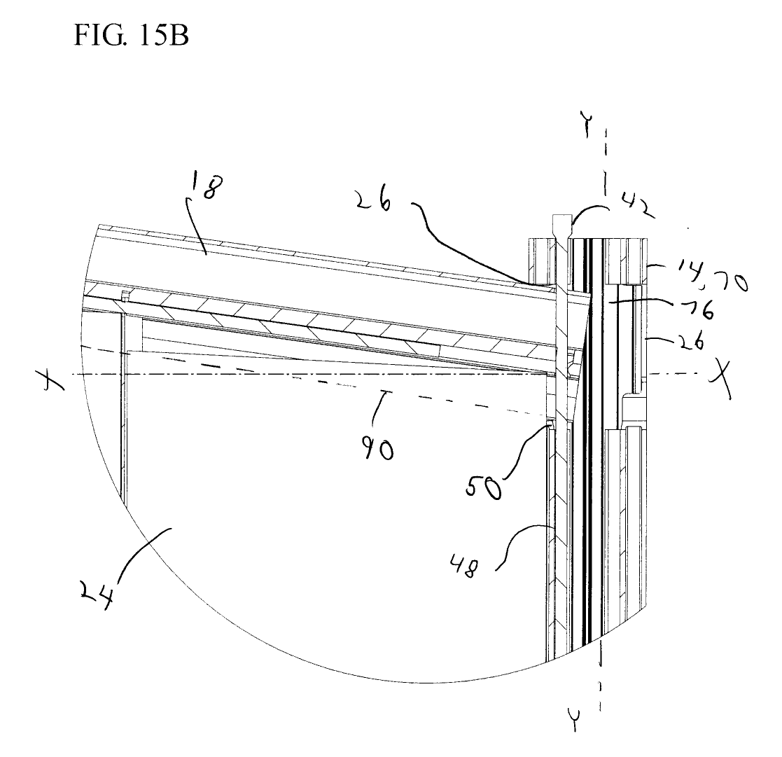

With reference to FIGS. 12 and 15B, in the line post 70, opposing sidewalls of the post include top and bottom rail openings 26, 28 and a post slot 30 formed there between. The opposing sidewalls also include a pocket 50 surrounded by walls 51. A retainer 46 is also secured to the inside of the opposing sidewalls and is used to secure the posts to the top and bottom rails 18, 20 as will be described below. This permits the line post 70 to join fence panels 12 together in a generally straight line. In corner posts 72 (FIG. 13), adjacent sidewalls each include the retainer 46, top and bottom rail openings 26, 28, post slot 30 and the pocket 50 and walls 51. In a generally square post, the sets of top and bottom rail openings 26, 28 are at a right angle to each other. Therefore, the corner post 72 may be used when joining panels at right angles to each other such as in a corner. The end post 74 (FIG. 14) may include a retainer 46, top and bottom rail openings 26, 28, and a post slot 30 on only one side wall, since such a post is only attached to the end of one panel 12. It is within the contemplation of the present invention that posts 14 could be formed with sets of rail openings on more than two sides and that the location of the openings are radially offset by angles other than 90 degrees. Preferably, in each type of post the rail openings 26, 28 and slot 30 are formed in a manner similar to that described with respect to the line post 70.

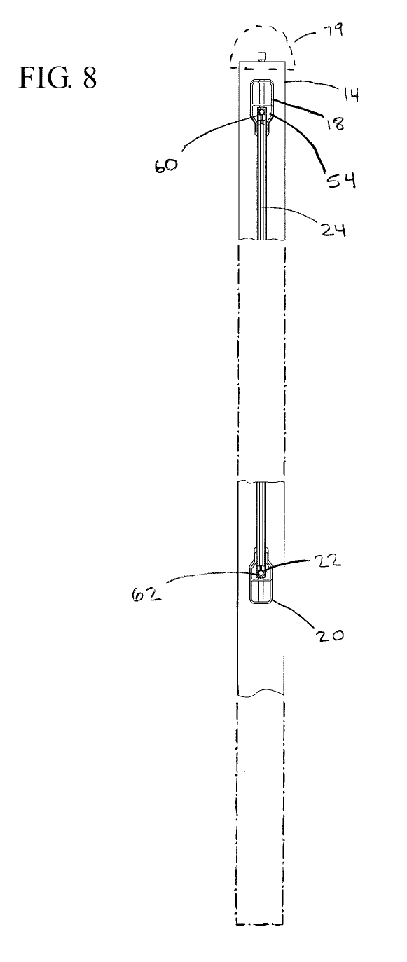

With reference to FIGS. 3, 4 and 12, the top and bottom rails 18, 20 are secured to the posts via a rail locking apparatus 40. The rail locking system 40 may include a post rod 42 which extends through an elongated aperture 44 formed in the ends of the top and bottom rails 18 and 20 and an opening 45 formed in the rail cross member 67. The rail locking apparatus 40 may further include the retainer 46 fixedly secured to the post interior 76. Retainer 46 may include a channel 48 which receives post rod 42 in a close fitting manner. The retainer channel 48 may extend along the length of the post. The channel 48, and walls 51 forming the pocket 50, may be interrupted at the position of the top and bottom rail openings 26, 28 in order to permit the ends of the rails to enter the post interior 76. Retainer 46 may be secured to the joining walls 16 of the post. Accordingly, when the top and bottom rails are inserted into the joining wall 16 through the top and bottom rail openings 26, 28, the aperture 44 may align with the retainer channel 48. The post rod 42 may be inserted through a top opening 77 of the post into the retainer channel 48 and into the aperture 44 of the top and bottom rails 18, 20 thereby securing the top and bottom rails to the posts 14. A post cap 79 (FIG. 8) may be attached to the top of the post 14 to cover the top opening 77. This manner of securement permits the top and bottom rails 18 and 20 to pivot to some degree with respect to the post 14; therefore, the angle at which the rails 18, 20 meet the posts 14 can be varied. This permits racking of the panel 12 as described below. The securement of the top and bottom rails 18 and 20 to the posts 14 also is achieved without any elements of the rail locking apparatus being visible from an exterior view once the top and bottom rails of the fence panels 12 are secured to the posts 14. Accordingly, either side of the fence panel provides a clean pleasant look absent the appearance of fastening elements.

As shown in FIG. 12, the retainer 46 may be disposed on one of the pocket walls 51 and is therefore offset a distance from the inner surface of the post sidewall. Accordingly, the retainer 46 is located outside of the pocket 50 such that the post rod 42 may be inserted into the retainer and rails 18, 20 without interfering with the board 24, the edge 25 of which resides within the pocket 50.

With each of the various types of posts 14, the manner of securing the panel 12 thereto is essentially the same. The top and bottom rail end portions are inserted into the respective top and bottom openings 26, 28 in the side of the post. The side edge 25 of the board 24 adjacent the post is inserted into the post slot 30. A post rod 42 would be inserted into the retainer 46 through the openings 45 in the ends of the top and bottom rail thereby securing the panel 12 to the posts 14.

With reference to FIGS. 15A and 15B, construction of the fence panel 12 and the manner of attaching the top and bottom rails 18, 20 to the posts 14 and the pickets 22 to the top and bottom rails, allows for some movement between the bottom and top rails 18, 20. The top and bottom rails 18, 20 may be shifted relative to each other along there longitudinal extents L-L as shown by arrows in FIG. 15A. This movement allows the fence panels 12 to rack such that when the panel is attached to posts 14, the post at one end of the fence panel 12 may be at a different elevation than the post on the other end of the fence panel. However, the vertically aligned members such as the pickets 22 and boards 24 maintain a generally vertically plumb orientation while the horizontal elements such as the top and bottom rails 18, 20 may follow the contour of the terrain. The rackable fence panel 12 is, therefore, able to accommodate the grade of the surface on which it is installed.

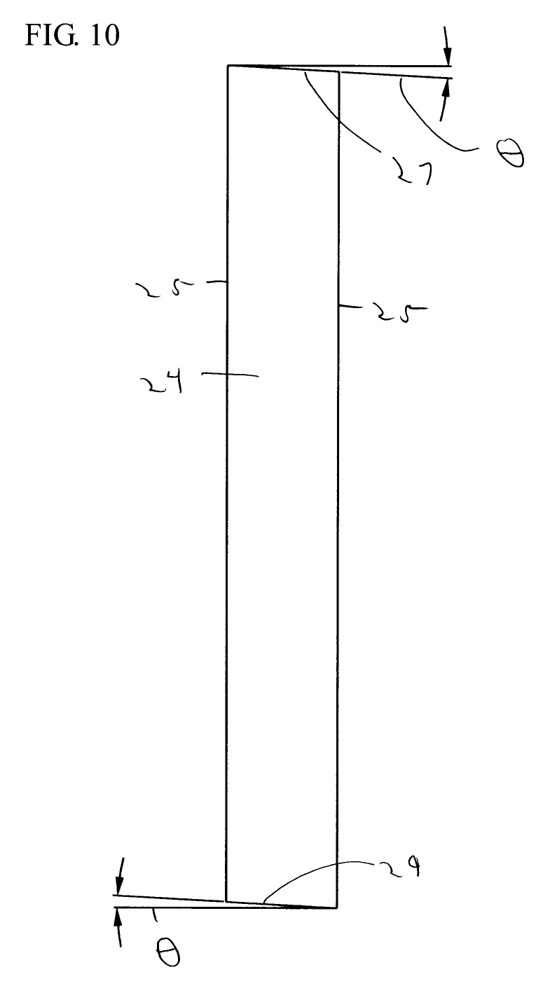

As noted above with reference to FIG. 10, the top and bottom edges 27, 29 of the boards may be formed to assist the racking feature of the fence panel 12. When the fence panel 12 is racked in order to accommodate a particular terrain or mounting configuration, the posts 14, pickets 22, and boards 24 remain in a generally vertically plumb orientation. However, the top and bottom rails edges 27, 29 tend to follow the terrain's contour; and therefore, the top and bottom rails will assume a non-orthogonal orientation with respect to longitudinal axes Y-Y of the posts 14 and pickets 22. The plurality of boards 24 may be inserted in a fence panel 12 such that the top and bottom edges of the boards 24 all slope in the same direction as shown in FIG. 15A. The fence panel 12 may be racked such that the slope of the top and bottom rails 18, 20 will be the same general direction as the slope in the top and bottom edges of the boards 24. Accordingly, when the fence panel 12 is racked, such that the top rail and bottom rails are shifted relative to each other along their longitudinal extents L-L, the slope of the top and bottom edges 27, 29 generally follow the incline of the top and bottom rails 18, 20, thereby permitting greater racking capability as shown in FIG. 15B.

In addition, by sloping or angling the board top and bottom edges 27, 29, these edges remain within the top and bottom rail channels 52 when the fence panel 12 is racked. As shown in FIG. 15B, when the panel is racked, the top edge 27 is above the bottom lip 90 of the rail. Therefore, no openings will be created between the boards 24 and the rails 18, 20, and the privacy feature of the fence panel 12 is maintained. The top and bottom rail 18, 20 may be sloped a greater degree than the slope of the board edges. For example, the board edges may be sloped relative to a horizontal axis X-X at a 3 degree angle and the rails may slope at a 10 degree angle. Such slope angles are by way of example and not intended to be limiting. Since the board edges 27, 29 are inserted a certain amount into the interiors of the top and bottom rail channels, when the panel 12 is racked, the edges of the board are not exposed even when the rails 18, 20 slope more than the board top and bottom edges 27, 29.

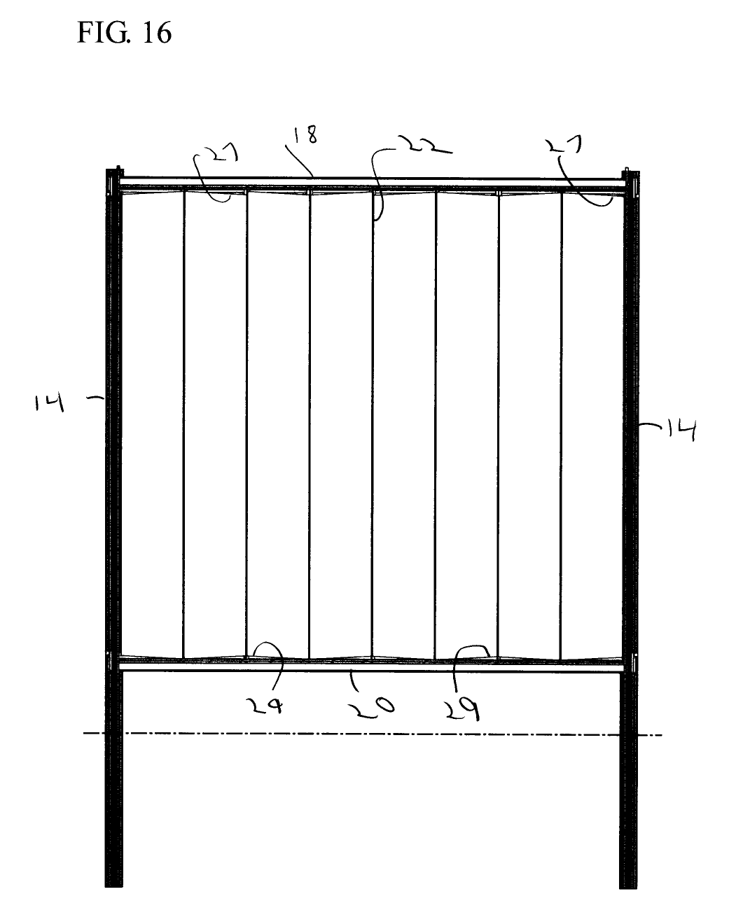

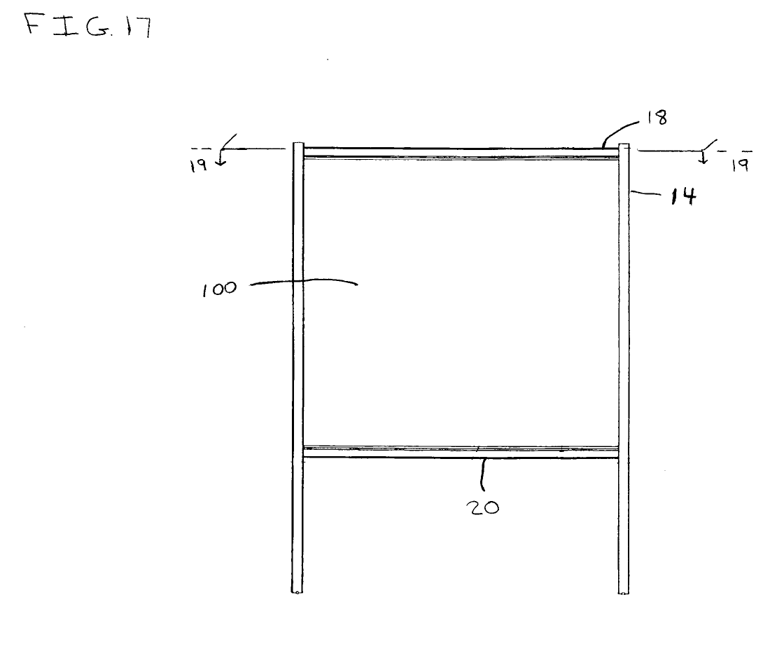

Alternatively, as shown in FIG. 16, the boards 24 may be assembled within the fence panel 12 such that the position of the boards is alternated. Therefore, the top and bottom sloping edges 27, 29 alternate directions between adjacent boards 24. This configuration resists racking since the adjacent corners of the boards 24 will engage the inside of the top and bottom rails and resist the rails from moving out of square relative to the pickets 12 and boards 24. Such a configuration may be used when maintaining the fence panel in a squared orientation is desired and the racking feature is not needed.

The fence panel 12 may be preassembled such that the rails, pickets and boards are secured together. Each of the members is thereby retained to each other in a unitary structure. This makes for ease of shipping the product as well as installation of the panel at the job site. A plurality of fence panels 12 may be delivered to a job site along with the requisite number and styles of posts. An installer would need only to install the posts and insert the fence panels 12 between the posts and lock the rails to the posts 14 using the post rods 42. This preassembled fence panel 12, which contains no openings there through provides a high degree of privacy. In addition, the preassembled panel 12 may be racked without any modification to the panels 12 at the installation site. When the fence panel 12 is racked, the privacy feature is maintained since the boards 24 continue to extend into the top and bottom rails 18, 20 at the tops and bottoms and the pickets and/or posts at the side longitudinal edges.

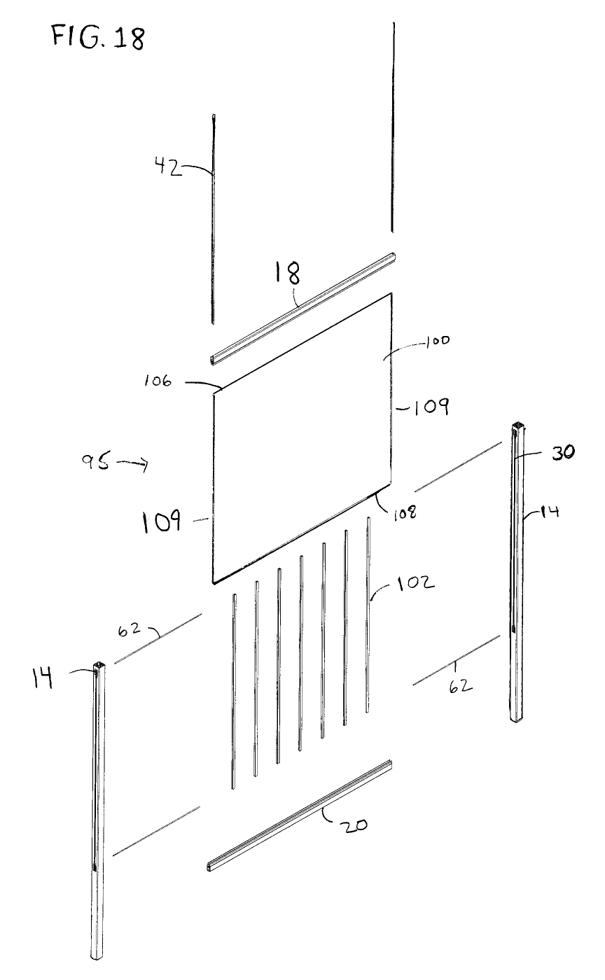

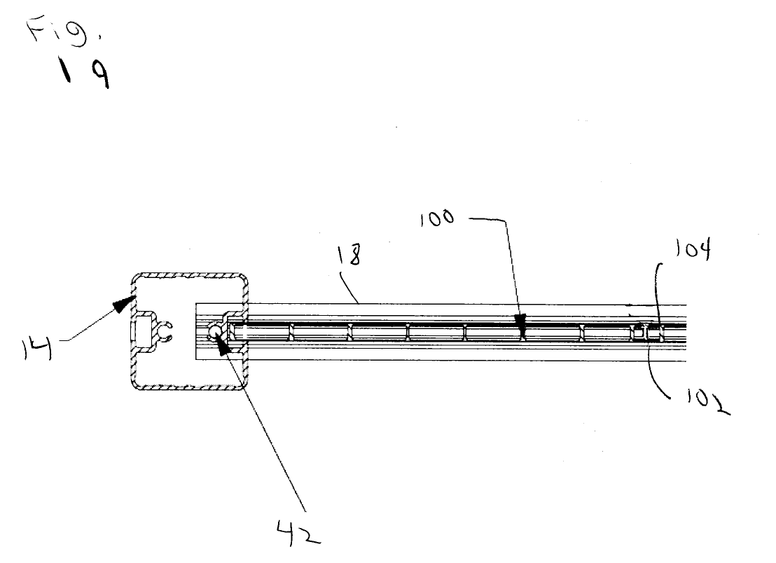

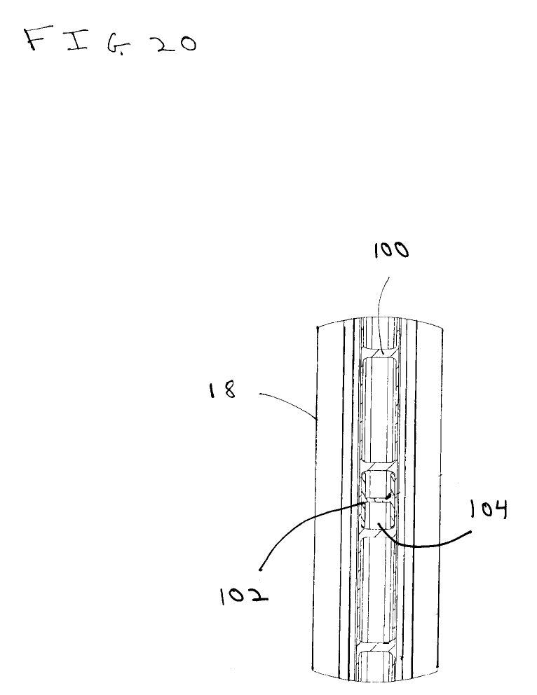

A further embodiment is shown in FIGS. 17-20. In this embodiment, the fence panel 95 may include a single board 100 which extends between the two posts 14. The top and bottom rails 18, 20 and posts 14 are substantially the same as those described above. Board 100 may include a plurality of spaced, longitudinally extending passages 104. Pickets 102 may be elongate longitudinally extending members that extend though the passages 104 and into the top and bottom rails 18, 20. Pickets 102 may have an H-shaped cross-sectional profile, although it is within the contemplation of the present invention that the pickets could be formed in a variety of configurations. The board 100 may be formed with patterns thereon to provide a desired aesthetic.

The top and bottom edges 106, 108 of the board 100 may extend into the channel of the top and bottom rails. The opposed board side edges 109 may extend into the post slots 30. The top and bottom rails 18, 20 may be secured to the posts 14 using post rods 42 in the same manner as described above. The board 100 may be formed of a variety of materials including plastics, PVC, composite material, metal or wood. The board 100 may be formed of, or coated with, opaque material in order to provide the privacy feature.

In order to assemble the panel 95, pickets 102 are inserted through the board channels 104. The pickets 102 are sized so that the picket ends extend beyond the end of the board 100. The picket ends include through-holes (not shown). The through-holes permit a rail rod to extend there-through to secure the pickets 102 in a manner similar to that of the previously described embodiment.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A fence system comprising:
a top rail and bottom rail spaced from each other and having opposing ends;
a plurality of spaced elongate members extending between the top and bottom rails, adjacent elongate members of the plurality of elongate members defining a space therebetween;
a plurality of boards with one of the plurality of boards being disposed in the spaces formed by the elongate members, the plurality of boards including opposed side edges; and
a pair of posts spaced from one another and securable to the ends of the top and bottom rail, the posts each including a peripheral wall defining a post interior, the peripheral wall having a first and second rail opening formed therein for receiving the ends of the top and bottom rail respectively, the ends of the top and bottom rails extending into the post interior, the peripheral wall further including a slot formed therein, the slot extending along a portion of a length of the post between, and being bounded by, the first and second rail openings, the slot receiving therein a side edge of one of the plurality of boards.

2. The fence system as defined in claim 1, wherein the elongate members include grooves formed on opposing sides and ends of the boards are received in the elongate member grooves.

3. The fence system as defined in claim 2, wherein the posts, the plurality of elongate members, and the plurality of boards form a solid wall devoid of openings.

4. The fence system as defined in claim 1, wherein the rails are coupled to the posts and the elongate members are coupled to the top and bottom rails.

5. The fence system as defined in claim 1, wherein the top and bottom rails are pivotable with respect to the posts and the elongate members are pivotable with respect to the bottom and top rail.

6. The fence system as defined in claim 5, wherein the boards are slidable with respect to the elongate members.

7. The fence system as defined in claim 6, wherein the boards are movable relative to the top and bottom rails.

8. The fence system as defined in claim 1, wherein the boards include a top and bottom edge, and the top and bottom edges extend in a non-orthogonal orientation between the opposed side edges.

9. The fence system as defined in claim 8, wherein the top and bottom board edges are shaped to facilitate movement of the top and bottom rail relative to each other.

10. The fence system as defined in claim 9, wherein the plurality of boards are disposed between the elongate members wherein the top and bottom edges slope in the same direction.

11. The fence system as defined in claim 8, wherein adjacent board of the plurality of boards are disposed between the elongate members wherein the top and bottom edges slope in different directions.

12. The fence system as defined in claim 1, wherein the first and second rail openings and slot are formed by removing material from the peripheral wall.

13. The fence system as defined in claim 1, wherein the first and second rail openings include a periphery bounded by the post peripheral wall, wherein the peripheral wall restricts movement of the top and bottom rails in a direction along the length of the post.

14. The fence system as defined in claim 13, wherein the posts are formed of one piece.

15. The fence system as defined in claim 1, further including a rail locking system for securing the top and bottom rails to the posts, the rail locking system being disposed within a post interior and coupled to and offset from the peripheral wall.

16. The fence system as defined in claim 15, wherein the rail locking system is not visible from an exterior view upon assembly of the top and bottom rails to the posts.

17. A rackable fence panel comprising:
a top rail and bottom rail spaced from each other and having opposing ends;
a plurality of spaced elongate members extending between the top and bottom rails, adjacent elongate members defining a space therebetween;
a plurality of boards with one of said plurality of boards being disposed in each of the spaces formed by the elongate members; and
a securement apparatus operably connecting the elongate members to the top and bottom rails and retaining the boards disposed between the elongate members, the top and bottom rail being shiftable relative to each other along longitudinal extents thereof.

18. The fence panel as defined in claim 17, wherein the boards are movable relative to the top and bottom rails and the elongate members.

19. The fence panel as defined in claim 17, wherein the elongate members are pivotable with respect to the top and bottom rails.

20. The fence panel as defined in claim 17, wherein the boards include a top and bottom edge, and the top and bottom edges extend in a non-orthogonal orientation between the opposed side edges.

21. The fence panel as defined in claim 20, wherein the plurality of boards are disposed between the elongate members wherein the top and bottom edges slope in the same direction to facilitate the shifting of the top and bottom rails relative to each other.

22. A fence system comprising:
a top rail and bottom rail spaced from each other and having opposing ends;
a plurality of spaced elongate members extending between the top and bottom rails, adjacent elongate members defining a space therebetween;
a board including a plurality of passages extending there-through, one of the plurality of elongate members extending through each of the plurality of channels;
a securement apparatus operably connecting the elongate members to the top and bottom rails.

23. The fence system as defined in claim 22, wherein the top and bottom rails include a channel and portion of the board sits within the channel of the top and bottom rails.

24. The fence system as defined in claim 22, including a pair of posts secured to opposite ends of the top and bottom rail.

25. The fence system as defined in claim 24, wherein the pair of posts each include a slot therein for receiving an edge of the board.

26. A method for forming a fence post comprising:
forming an elongate member having a peripheral wall bounding an interior;
removing portions of the peripheral wall to form a first and second opening adapted to each receive an end of a fence rail; and
removing a section of the peripheral wall between the first and second openings to form a slot for receiving a portion of a fence panel.
